(19) United States
(12) Patent Application Publication
(10) Pub. No.: US 2026/0014500 A1
(43) Pub. Date: Jan. 15, 2026

(54) MIKVAH SANITATION DEVICES

(71) Applicant: MikvaTech Pool Purity Ltd, Jerusalem (IL)

(72) Inventors: Jonathan Jacob Heller, Jerusalem (IL); Jonathan Elmaleh, Brooklyn, NY (US)

(21) Appl. No.: 19/263,346

(22) Filed: Jul. 8, 2025

Related U.S. Application Data
(60) Provisional application No. 63/669,249, filed on Jul. 10, 2024.

(51) Int. Cl. B01D 35/26; A47G 33/00; B01D 29/11; B01D 29/52; B01D 29/92; C02F 1/00; C02F 103/42; E04H 4/12

(52) U.S. Cl. CPC B01D 35/26; A47G 33/00; B01D 29/11; B01D 29/52; B01D 29/92; C02F 1/001; E04H 4/1218; B01D 2201/4046; B01D 2201/64; C02F 2103/42; C02F 2201/006; C02F 2301/046

(57) ABSTRACT

A mikvah sanitation device has a longitudinal axis and includes an outer axially extending housing and a plurality of filter cartridges extending axially one alongside the other within the housing. The filter cartridges are maintained in a pre-defined position within the sanitation device during use such that in a cross section perpendicular to the longitudinal axis the filter cartridges are distanced one from the other by a minimal distance that is sized to be least about 25 millimeters and in an enhancement (hiddur) at least about 48 millimeters in order to provide a passage between the filter cartridges that fulfills the criteria of ‘mouthpiece of a drinking pouch’ (shfoferes hanod).

### TECHNICAL FIELD

Embodiments of the invention relate to mikvah sanitation devices, in particular for improving sanitation conditions in a body of water of a mikvah in which believers bathe to achieve ritual purity.

### BACKGROUND

Classical rabbinical literature dictates many rules relating to the construction of a mikvah (or mikveh). For example, a mikvah has to be connected to a source of naturally occurring water, it must contain sufficient water to cover the entire body of an average-sized person; and the required volume of water should be about 40 seah.

Additional requirements dictate the manner in which the water can be stored and transported to or within the mikvah. For example it is forbidden for the water to pass through any vessel which could hold water within it. If however a vessel has an ‘opening’ that is large enough to fulfill a criteria called ‘mouthpiece of a drinking pouch’ (shfoferes hanod)—then the vessel may be used for filling or channeling water in a mikvah.

The booklet “Understanding Mikvah: An Overview of Mikvah Construction” by the author ‘Rabbi Schneur Zaiman Lesches’; ISBN 0-9689146-0-8 (2001); specifies many of the requirement relating to a Mikvah. It specifies, inter alia, at pages 43 and in particular 44 and footnotes 67, 72 and 73 that an ‘opening’ in a vessel that qualifies as a ‘mouthpiece of a drinking pouch’ should be large enough for two average fingers to fit in and rotate.

The booklet further details that the dimension of such an ‘opening’ equals to a quarter of a tefach (the common measure for one tefach as used in modern mikvah's is 10 centimeters); and thus according to this measurement such an ‘opening’ could be as small as about 25 millimeters in width (see footnotes 67 and 72). In an enhancement (hiddur) that goes beyond the formal demands of rabbinical law—an ‘opening’ qualifying as a ‘mouthpiece of a drinking pouch’ should be at least 48 millimeters in width (see footnote 73).

Rabbinical rules relating to the purity and hence cleanliness and sanitation of the body of water in a mikvah are strictly followed, and thus to avoid unfit water, the water in a mikvah can often be completely drained away and refilled from scratch resulting in large quantities of water that are wasted. In cases where water in the Mikvah is heated, re-filling a Mikvah with new water requires re-heating the water, a process that is wasteful in energy. Thus, being able to use the water in the mikvah for longer periods of time, while maintaining water cleanliness and the required purity of the water for its intended religious ritual, is advantageous.

There are various further halachic guidelines relating to immersing in a mikvah, such as immersion of an inverted vessel, which is designed to ensure that the immersion is valid and the vessel is properly purified.

These halachic guidelines define that when a vessel is inverted (turned upside down) during immersion, it is important to ensure that no air pockets remain inside the vessel, since air pockets can create a barrier (chatzitzah) between the water and the vessel, invalidating the immersion. Further more, the Mishna in tractate Mikvaot chapter 5, Mishna 2 discusses the laws of filling a mikvah with spring water that flows over a vessel “kli” as it fills the mikvah. The noted commentary of Rabbi Ovadia Bartenura explains that this refers to filling the water in the mikvah as it flows over the outer external side of a “kli”. The halachic guidelines in this regard thus address the concern that water running over the outside external side of a vessel is problematic for use in a mikvah just like water that is inside the vessel itself.

In another example, the halachic guideline “connected” or “flow-through” (also known as “hashakah” or “zeriah”) refers to specific methods that ensure the mikvah water maintains its ritual purity by being connected to a kosher water source. The connection path should be clear of any obstructions to allow the free flow of water between the mikvah and the kosher pool.

### SUMMARY

The following embodiments and aspects thereof are described and illustrated in conjunction with systems, tools and methods which are meant to be exemplary and illustrative, not limiting in scope.

In a first broad, possibly independent, aspect—the present disclosure can be seen relating to an embodiment of a mikvah sanitation device having a longitudinal axis and comprising an outer axially extending housing and a plurality of filter cartridges extending axially one alongside the other within the housing, wherein the filter cartridges are maintained in a pre-defined position within the sanitation device during use such that in a cross section perpendicular to the longitudinal axis the filter cartridges are distanced one from the other by a minimal distance that is sized to be least about 25 millimeters and in an enhancement (hiddur) at least about 48 millimeters in order to provide a passage between the filter cartridges that fulfills the criteria of ‘mouthpiece of a drinking pouch’ (shfoferes hanod).

In a further broad, possibly independent, aspect—the present disclosure can be seen relating to an anchoring mechanism for anchoring a sanitation device in place within the mikvah during use and comprising hollow telescopic pole that is axially adjustable and an arrangement of a spherical bearing and a socket at an upper side of the telescopic pole that imparts flexibility in movement and alignment to the anchoring mechanism.

In yet a further broad, possibly independent, aspect—the present disclosure can be seen relating to a system comprising a cable harness, a housing and an electrical appliance that is substantially sealingly located within the housing, the housing and electrical appliance being configured during use of the system to be submerged within a body of water, wherein the cable harness comprises electrical wires for powering the electrical appliance and a hollow tube for providing fluid communication between an interior of the housing and a location outside of the housing, preferably outside of the body of water.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows a top view of a mikvah in which believers bathe to achieve ritual purity and an embodiment of a sanitation device located in a body of water of the mikvah;

FIG. 2 schematically shows a perspective view of the sanitation device seen in FIG. 1 and an embodiment of an anchor mechanism for anchoring the sanitation device in place within the mikvah during use;

FIG. 3 schematically shows an exploded view of the sanitation device;

FIGS. 4A and 4B schematically show perspective top and bottom views of the device's top basket;

FIG. 5A schematically shows a perspective side view of a top portion of the sanitation device with its outer housing and top float partially transparent revealing locating pegs of the device's top basket engaging/interacting and maintaining in place top regions of filter cartridges of the device;

FIG. 5B schematically shows a top view of the sanitation device with a top basket of the device being removed revealing an arrangement of filter cartridges of the sanitation device as seen from above;

FIGS. 6A and 6B schematically show perspective top and bottom views of the device's top float;

FIG. 7 schematically shows a perspective bottom view of filter cartridges of the sanitation device;

FIGS. 8A and 8B schematically show perspective top and bottom views of the device's base;

FIGS. 9A and 9B schematically show perspective bottom views of the device's base with its lower plate being removed revealing its interior, with FIG. 9B being a partial exploded view in which an exit port of the device is moved from its location within the device;

FIGS. 10A and 10B schematically show, respectively, a closer view of the base's interior revealing it propeller, and an inner side of the housing block that is adapted to face and engage with the propeller;

FIGS. 11A to 11C schematically show the anchor mechanism of the sanitation device in accordance with various embodiments; and

FIG. 12 schematically shows an embodiment of a cable harness in accordance with an aspect of the present disclosure, and its interaction with an electrical appliance sealingly housed within a housing that is intended for use under water.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

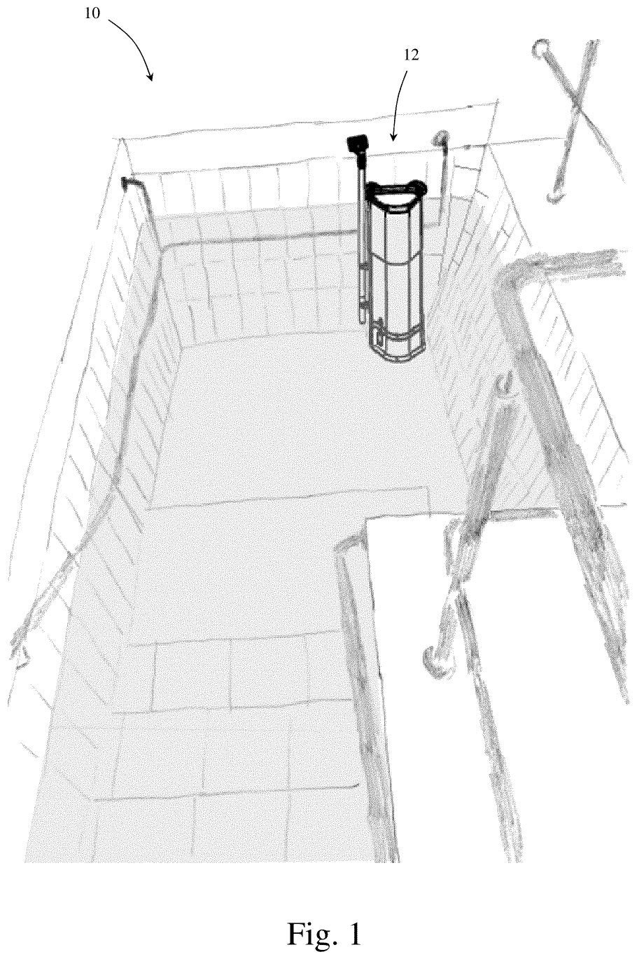

Attention is first drawn to FIG. 1 schematically showing a top view of a mikvah 10 in which believers bathe to achieve ritual purity and an embodiment of a sanitation device 12 located in a body of water of the mikvah.

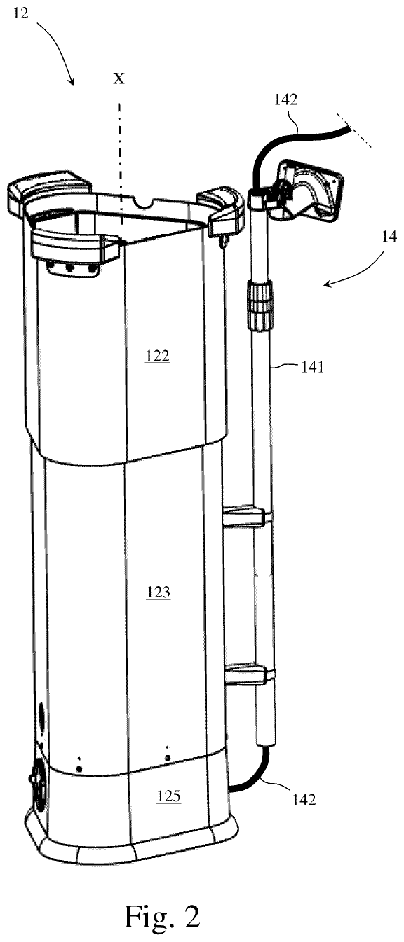

With attention drawn to FIG. 2 the sanitation device 12 can be seen equipped in this example with an anchoring mechanism 14 for anchoring the sanitation device 12 in place within the mikvah during use.

The anchoring member 14 includes a telescopic pole 141, and in this example a conduit bundle 142 may be threaded through the pole 141 towards the sanitation device.

Distinct conduits or cable harnesses within conduit bundle 142 may be used for providing various utilities to the sanitation device, such as for routing electrical wirings, tubes or cables (or the like) from an external located towards the device, and/or for channeling gaseous from a source outside of the device to assist in the sanitation process and the like.

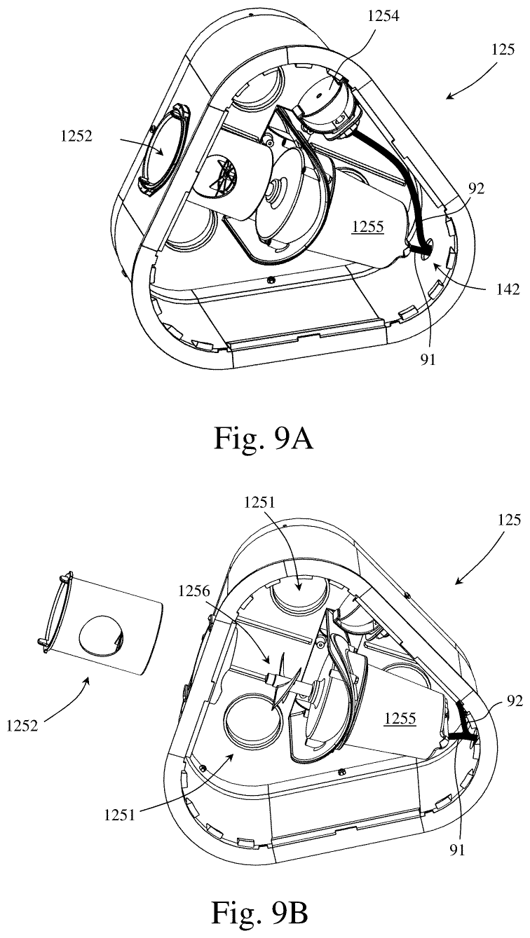

In FIGS. 9A and 9B, cable harness 91 schematically represents electrical wirings routed towards a motor (not seen) and possibly also a tube that is routed towards a motor box 1255, which substantially seals the motor from contact with the body of water in which it is located. Conduit 92 in these FIGS. 9A and 9B schematically represents a conduit for channeling gaseous from a source outside of the device to assist in the sanitation process.

In one non-binding example, gaseous channeled towards the sanitation device may be treated oxygen, such as oxygen irradiated with UV radiation in the presence of an induced magnetic field to form the treated oxygen.

The sanitation device has a longitudinal axis X and is adapted to collect water at its axial upper open side and release the water back into the body of water of the mikvah at its axial lower side.

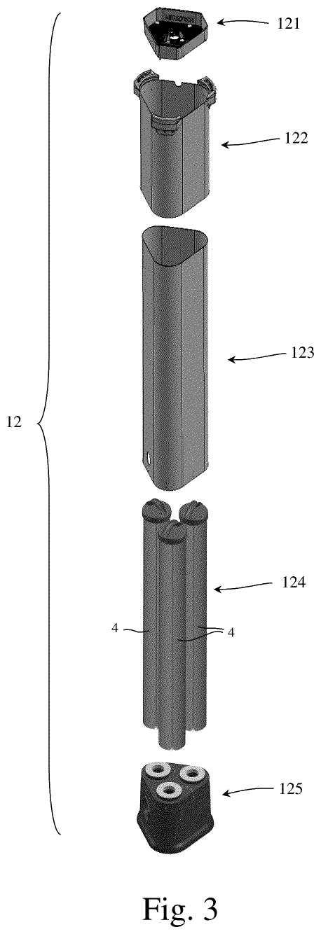

With attention drawn to the exploded view of FIG. 3, the sanitation device 12 can be seen including the following components: an upper basket 121, a top float 122, an outer housing 123, a filter cartridge arrangement 124 (here including three filter cartridges 4) and a lower base 125.

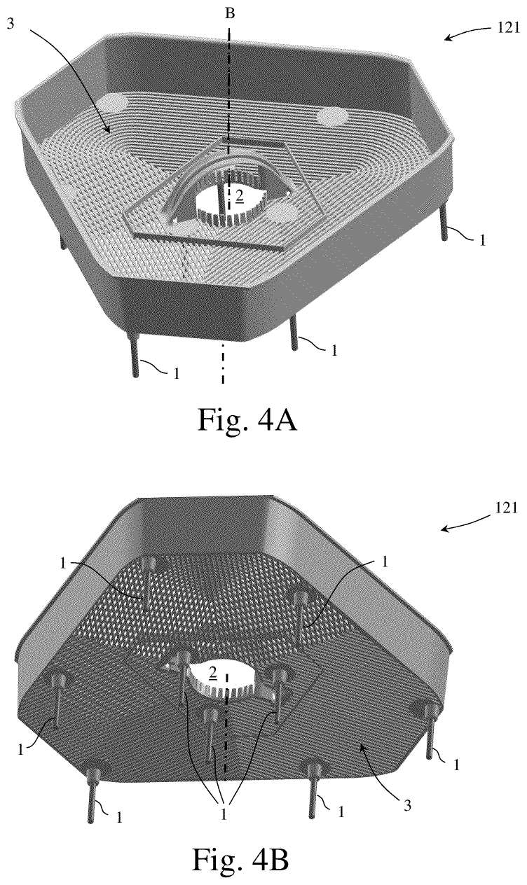

Attention drawn to FIGS. 4A and 4B schematically showing perspective top and bottom views of the device's top basket 121 in accordance with an embodiment of the present invention.

As seen, the top basket 121 is formed about a central axis B and includes a mesh 3 that is generally orthogonal to axis B and is designed to capture and retain solid particles such as hair, dirt, and other debris.

The top basket 121 is designed to be placed at the upper side of the sanitation device with its axis B generally aligned with the sanitation device's axis X, in order to prevent or limit entry of such solid particles into the sanitation device as water is sucked into the device at its upper side.

An open passage 2 formed about axis B in this example is generally located at the center of the mesh 3.

In at least certain embodiments, passage 2 may be sized to define a route into the sanitation device that has a cross sectional extension (e.g. diameter) of at least about 25 millimeters (or more); and in an enhancement (hiddur) at least about 48 millimeters (or more)—in order to provide an ‘opening’ between the main body of water of the mikvah and the water passages within the sanitation device—that fulfills the criteria of ‘mouthpiece of a drinking pouch’ (shfoferes hanod).

As best seen in FIG. 4B, the top basket 121 is equipped with pegs 1 that project axially downwards from a lower side of the basket's mesh 3.

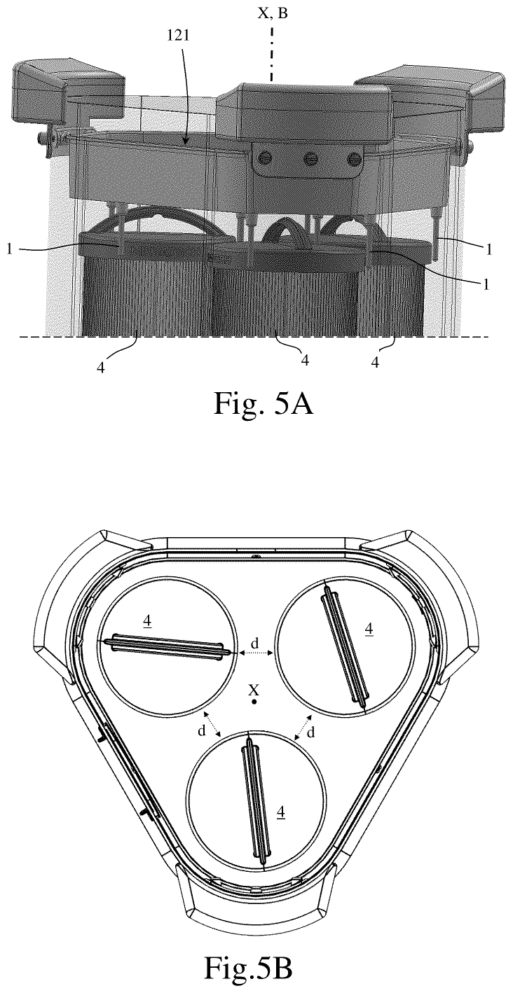

With attention drawn to FIG. 5A, the top basket 121 when positioned within the sanitation device is located such that its pegs 1 project downwards and engage/interact with the upper ends of the filter cartridges 4 of the sanitation device in order to assist in maintaining the filter cartridges 4 in their intended pre-defined position within the sanitation device, generally alongside axis X of the device.

In the top view of the sanitation device seen in FIG. 5B, the filter cartridges 4 can be seen in their intended pre-defined position within the sanitation device.

In this intended pre-defined position, the filter cartridges 4 are maintained within the sanitation device such that in a cross section perpendicular to axis X they a distanced one from the other by a minimal distance ‘d’ that is sized to be least about 25 millimeters (or more); and in an enhancement (hiddur) at least about 48 millimeters (or more)—in order to provide a ‘passage’ between the filter cartridges, which fulfills the criteria of ‘mouthpiece of a drinking pouch’ (shfoferes hanod).

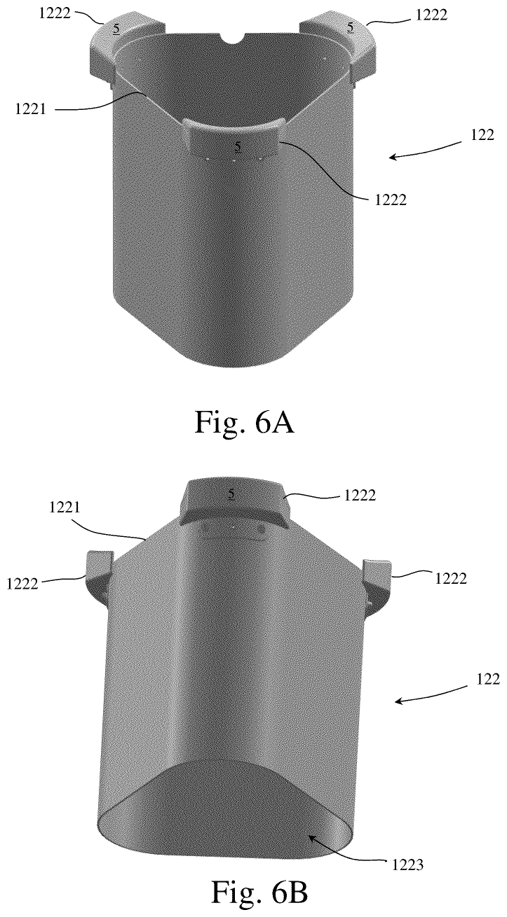

Attention is drawn to FIGS. 6A and 6B schematically showing perspective top and bottom views of the device's top float 122.

The top float 122 is arranged to have a buoyancy that maintains its upper edge 1221 just above and/or generally flush with the upper surface of the water in the mikvah.

Such buoyancy may be provided as seen in this example by positioning float members 1222 adjacent the top side of the top float. The float members may each be designed to include foam material that is enclosed within a casing 5 of its respective float member—so that the foam material does not contact the water in the mikvah.

The density of the foam within the float members 1222 may be chosen to have suitable air pockets relative to its mass in order to impart to the top float 122 a buoyancy that maintains its upper edge 1221 just above and/or generally flush with the upper surface of the water.

A typical design normally employed for providing buoyancy in elements such as the top float of the present disclosure—is to create air pocket that open to its lower side. In such a design, air trapped within the pockets reduces the overall density of the object and by that increases its ability to float.

By designing the float members of the present disclosure to have a foam material enclosed within a casing 5, the presently disclosed float members fulfill, inter alia, the halachic guideline of an “inverted vessel”. This halachic guideline is designed to ensure that when a vessel (here top float) is inverted (turned upside down) during immersion, no air pockets remain inside the vessel that may create a barrier (chatzitzah) between the water of the mikvah and the vessel.

The top float 122 is formed about an axial extending through going passageway 1223 that is designed to fit over the outer housing 123 of the sanitation device and by that allow the top float 122 to be axially slidable relative to the outer housing 123.

The sliding movement along the outer housing 123 is accordingly controlled by top float's buoyancy that ensures that the sanitation device at the top float's upper edge 1221 is located just above and/or generally flush with the upper surface of the water in the mikvah.

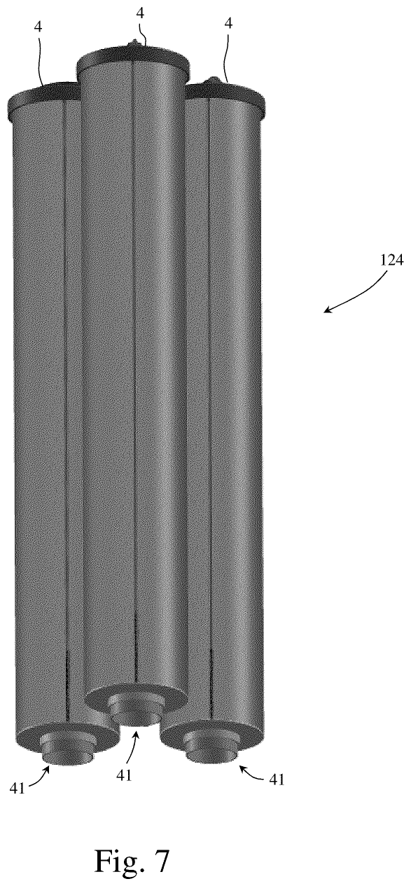

Attention is drawn to FIG. 7 schematically showing a perspective bottom view of a filter cartridge arrangement 124, which in this example optionally includes three filter cartridges 4. It is noted that any number of filter cartridges 4 can be included in a sanitation device in accordance with the various embodiments of the present disclosure.

As seen, in this embodiment each filter cartridge 4 includes at its axial lower side a collar 41. Each collar 41 communicates with filtered water that flows into the interior of the filter cartridge and is designed to channel this filtered cleaner water downwards into the base 125.

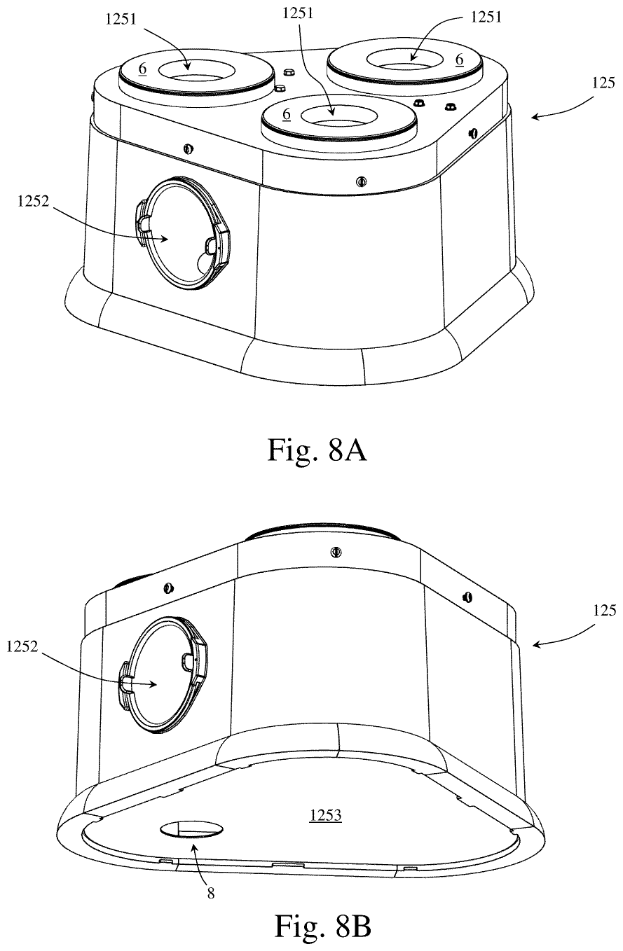

With attention additionally drawn to FIG. 8A, the device's base 125 can be seen including at its upper side three entry ports 1251 leading into the interior of the base 125. In this example, a ring shaped flange 6 is formed about each entry port 1251, and each filter cartridge 4 couples and communicates with a respective one of the entry ports 1251 at the base by placing its collar 41 within the ring shaped flange 6 and into the entry port 1251.

In certain embodiments, the entry ports 1251 may be formed generally tapering downwards, and the collars 41 may be suitably formed tapering downwards in order to assist in easy removal of the filter cartridges for maintenance, e.g. cleaning, and e.g. re-introduction of the filter cartridges back into the sanitation device for further use. The base also includes an exit port 1252 through which filtered water can be released back into the mikvah from the sanitation device.

With attention drawn to FIG. 8B, the base can be seen including a plate like member 1253 at its lower side. In certain cases, the lower plate like member may be detachably fitted to the base via snap fit engagement. In certain embodiments, the lower plate like member may be embodied as a net, e.g. made of nylon, which is enclosed within a peripheral frame. As seen, in this example a passage 8 fulfilling the criteria of ‘mouthpiece of a drinking pouch’ (shfoferes hanod) may be formed through plate like member 1253.

Attention is drawn to FIGS. 9A and 9B for perspective bottom views of the device's base with its plate like member 1253 being removed revealing its interior.

Within its interior, the base 125 can be seen including a motor box 1255 that houses an electrical motor (not seen in these figures) substantially sealing it from contact with the body of water within which it is located. Also seen is a propeller 1256 that is powered to rotate by the electrical motor.

A diffuser 1254 can be seen being located also within the base for diffusing and emitting arriving gaseous via conduit 92 (e.g. treated oxygen treated gas) to be mixed together with the filtered water being urged via exit port 1252 out of the device. An additional cable harness 91 as already discussed can accordingly be seen in this example routing electrical wires to power here motor and also possibly a tube for providing fluid communication between the interior of the motor box 1255 and a location outside of the device and the body of water in which the sanitation device is being used.

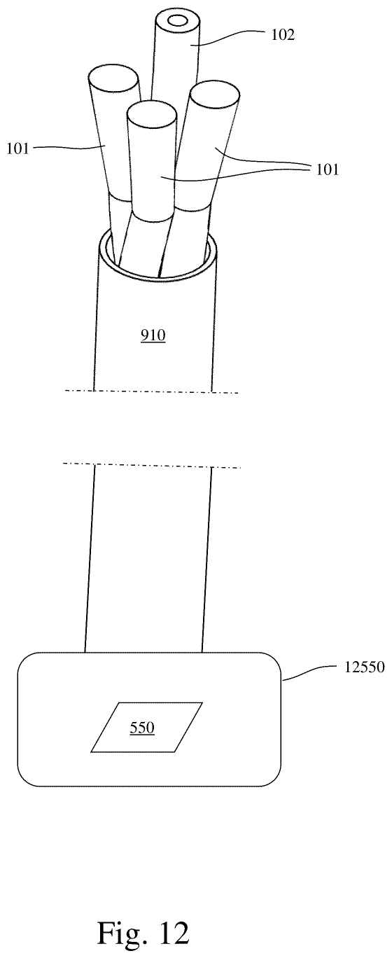

Attention is drawn to FIG. 12 schematically showing an example of a cable harness 910 in accordance with an embodiment of the present invention, which may be taken to represent the aforementioned cable harness 91.

In a broad aspect of the present disclosure there is provided a cable harness 910 for electrically powering an electrical appliance 550 intended for use within a body of water, while also providing fluid communication between an interior of a housing 12550 in which the electrical applicate is kept substantially sealed from the body of water.

It is noted that housing 12550 in this figure may be taken to represent the motor box 1255 in the aforementioned discussed example of the mikvah sanitation device, and the electrical appliance 550 may be taken to represent the electrical motor in the aforementioned discussed example of the mikvah sanitation device. However, it is to be understood that cable harness 910, housing 12550 and electrical appliance 550 may be of any type and may be used and implemented in a variety of devices that are intended to be submerged within water, such as a pool filter, a robotic pool cleaner, a pool skimmer, a remote controlled sail boat and AUV's (autonomous underwater vehicles) (etc.).

As seen in FIG. 12, cable harness 910 may include electrical wires 101 for powering electrical appliance 550 and a hollow tube 102 for providing fluid communication between the interior of housing 12550 and a location outside of the housing and preferably outside of the water.

In one example, the hollow tube 102 may be used for pumping gasses, e.g. air, into housing 12550 in order to assist in detecting, e.g. via appearance of bubbles exiting the housing, the degree of water tight sealing of the housing, which if breached may harm the electrical appliance 550 that is housed therein.

In another example, the hollow tube 102 may be used for releasing pressure that may build within the housing 12550 due to rise of temperature that is generated by electrical appliance 550. As the temperature increases, the air inside the housing 12550 expands, and this increase temperature and/or pressure if not released may harm the sealing of the housing 12550 and/or the electrical appliance 550 itself.

In one example, hollow tube 102 may lead out of housing 12550 to a control box (not shown) installed located outside of the water, e.g. in a machine room, and may connect to such a control box via a quick connector.

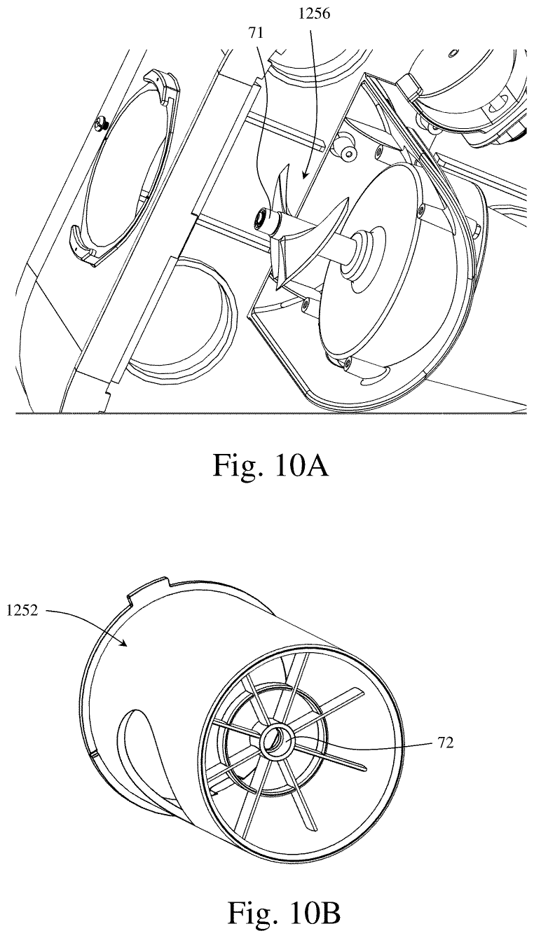

Attention is drawn to FIGS. 10A and 10B showing in detail the propeller 1256 and a rear side of exit port 1252. In an embodiment of the present disclosure, a tip 71 of the propeller may be supported during use within a support 72 formed at a rear inward facing side of exit port 1252 in order to support relative high rotational speeds of the propeller.

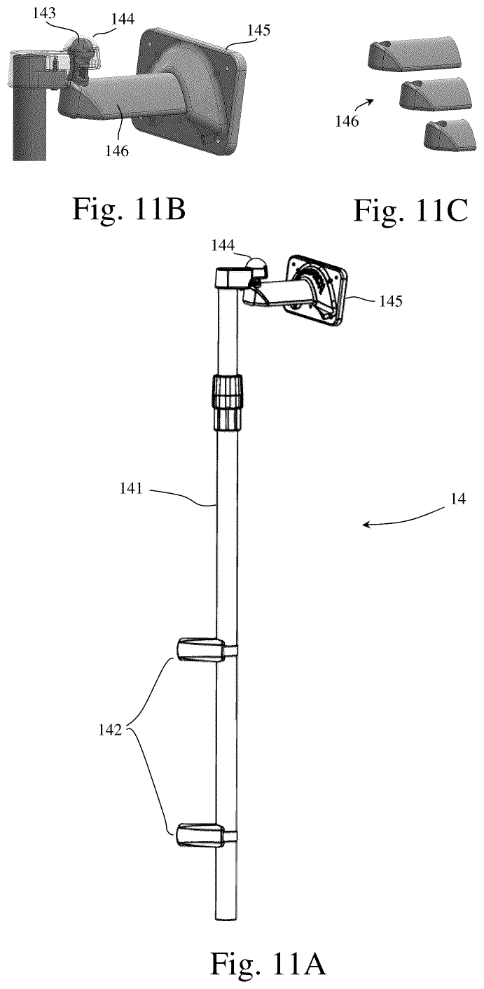

Attention is drawn to FIGS. 11A to 11C for a closer detailed view of the anchoring mechanism 14.

As seen, the anchoring mechanism 14 includes here two coupling members 142 for attaching the telescopic pole 141 to the sanitation device along its axial extension. At its upper side the anchoring mechanism 14 includes a socket 144 that fits over a spherical bearing 143 to impart flexibility in movement and alignment in this region of the mechanism.

A link rod 146 is attached at one of its ends to bearing 143 and at its other end to a connecting plate 145 that is designed to attach to a wall or any other firm structure adjacent the mikvah in order to secure the sanitation device in place within the mikvah during use.

The flexibility in movement and alignment imparted via the engagement between the socket 144 and bearing 143 assists adjusting the orientation of the connecting plate 145 to its desired location.

As seen in FIG. 11C, the anchoring member 14 may be equipped with link rods 146 of various lengths for a user to choose from when assembling the anchor mechanism.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Furthermore, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures can not be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

1. A mikvah sanitation device having a longitudinal axis and comprising an outer axially extending housing and a plurality of filter cartridges extending axially one alongside the other within the housing, wherein
the filter cartridges are maintained in a pre-defined position within the sanitation device during use such that in a cross section perpendicular to the longitudinal axis the filter cartridges are distanced one from the other by a minimal distance that is sized to be least about 25 millimeters and in an enhancement (hiddur) at least about 48 millimeters in order to provide a passage between the filter cartridges that fulfills the criteria of ‘mouthpiece of a drinking pouch’ (shfoferes hanod).

2. The mikvah sanitation device of claim 1 and comprising locating pegs that engage/interact with the filter cartridges in order to assist in maintaining the filter cartridges in their pre-defined position within the sanitation device.

3. The mikvah sanitation device of claim 2, wherein the locating pegs that engage/interact with upper ends of the filter cartridges.

4. The mikvah sanitation device of claim 3 and comprising a top basket located above the filter cartridges within the sanitation device, wherein the top basket comprises the locating pegs.

5. The mikvah sanitation device of claim 3 and comprising a top float that is axially slidable relative to the outer housing, wherein the top float comprising at least one float member comprising foam material enclosed within a casing that seals the foam material from contact with the ambient environment outside of the float member.

6. The mikvah sanitation device of claim 3 and comprising a base located axially below the outer housing,
the base comprising a plurality of entry ports each being associated with a respective one of the filter cartridges to provide fluid communication from the respective filter cartridge into the base, wherein
the base further comprises a motorized propeller for urging liquid flow into the base from the filter cartridges.

7. The mikvah sanitation device of claim 6, wherein the base further comprises an exit port through which liquid powered to flow into the base can be released out of the sanitation device.

8. The mikvah sanitation device of claim 7, wherein the exit port is detachably attached to the base.

9. The mikvah sanitation device of claim 7, wherein exit port comprises a support for engaging a tip of the propeller in order to support relative high rotational speeds of the propeller.

10. A method for filtering water in a mikvah comprising the steps of:
providing a sanitation device having a longitudinal axis and comprising an outer axially extending housing and a plurality of filter cartridges extending axially one alongside the other within the housing, wherein the filter cartridges are maintained in a pre-defined position within the sanitation device during use such that in a cross section perpendicular to the longitudinal axis the filter cartridges are distanced one from the other by a minimal distance that is sized to be least about 25 millimeters and in an enhancement (hiddur) at least about 48 millimeters, and
placing the sanitation device within the body of water of the mikvah so that the sanitation device collects water at its axial upper open side and releases the water back into the body of water of the mikvah at its axial lower side.

11. The method of claim 10 and comprising locating pegs that engage/interact with the filter cartridges in order to assist in maintaining the filter cartridges in their pre-defined position within the sanitation device.

12. The method of claim 11, wherein the locating pegs engage/interact with upper axial ends of the filter cartridges.

13. The method of claim 10 and comprising a step of providing an anchoring mechanism for anchoring the sanitation device in place within the mikvah during use.

14. The method of claim 13, wherein the anchoring mechanism comprising telescopic pole that is axially adjustable for suitably supporting the sanitation device in the body of water of the mikvah.

15. The method of claim 14 and comprising a step of threading a conduit bundle through the telescopic pole towards the sanitation device in order to support the operation of the sanitation device during use.

16. The method of claim 15, wherein the conduit bundle comprises a cable harness comprising electrical wires for providing electrical power to an electrical motor of the sanitation device.

17. The method of claim 16, wherein the cable harness comprises a hollow tube for providing fluid communication between a motor box of the sanitation device that substantially sealingly houses the electrical motor therein.

18. The method of claim 17, wherein the hollow tube is used for releasing temperature and/or pressure from within the motor box.

19. The method of claim 18, wherein the hollow tube is used for pumping gaseous, e.g. air, into the motor box in order to test the degree of water tight sealing of the motor box.

20. The method of claim 19, wherein the conduit bundle comprises a piping for channeling gaseous towards the sanitation device from a source outside of the device to assist in the sanitation process.
